(19) United States
(12) Patent Application Publication
(10) Pub. No.: US 2009/0300120 A1
(43) Pub. Date: Dec. 3, 2009

(54) METHOD AND SYSTEM FOR PRODUCING A PRESENTATION MESSAGE FOR A MOBILE DEVICE

(75) Inventor: Roland SCHMIDT, Vancouver (CA)

Correspondence Address: NEXUS LAW GROUP LLP, 1500 - 701 WEST GEORGIA STREET, VANCOUVER, BC, V7Y 1C6, CA

(73) Assignee: CONTEC INNOVATIONS INC., Port Coquitlam (CA)

(21) Appl. No.: 12/132,490

(22) Filed: Jun. 3, 2008

(51) Int. Cl. G06F 15/16

(52) U.S. Cl. 709/206

(57) ABSTRACT

A method and system produces a presentation message for a mobile device. The method involves retrieving syndicated content from a content source; and generating from the syndicated content the presentation message for sequentially presenting on the mobile device one or more content items of the syndicated content. The syndicated content may be a RSS or ATOM web feed. The method may involve receiving a user selection of a web feed and an invocation parameter; determining supported media types, display dimensions, maximum presentation message size and presentation parameters; retrieving the syndicated content; selecting the one or more content items; converting the one or more content items to one or more presentation objects; assembling the presentation objects into the presentation message; and delivering the presentation message to the mobile device such that viewing the presentation message causes the presentation objects to be sequentially displayed on the mobile device.

### BACKGROUND OF THE INVENTION

1. Field of Invention

This invention relates to electronic communications and, in particular, to a method and system for producing a presentation message for a mobile device.

2. Description of Related Art

Syndicated content, such as web feed content, can be provided by an information publisher to a subscribing user as a XML (Extensible Markup Language) file, which can be formatted in accordance with a syndication format such as RSS or ATOM. RSS is a family of XML (Extensible Markup Language) type formats, which includes formats related to Really Simple Syndication (e.g. RSS 0.9x, RSS 1.0, RSS 2.0). The ATOM syndicated format is a XML format developed for web feeds as an alternative to the RSS family of XML formats.

Some mobile communications devices, including mobile telephones such as cellular telephones and satellite telephones, personal digital assistants and other wireless communications devices, have installed feed reader software for receiving RSS or ATOM format web feeds and presenting a received web feed on a mobile communication device. However, such feed reader software must be directed by the user to receive a web feed each time the user wishes to receive that web feed, and such feed reader software is not able to sequentially present syndicated content.

Many mobile communications devices are able to receive messages transmitted in accordance with a messaging service. Short Message Service (SMS) permits users to receive short text messages such as text messages limited to 140 bytes in size. Multimedia Messaging Service (MMS) permits users to receive multimedia messages containing multimedia objects such as video, audio, images and formatted text, including multimedia messages up to 300 Kbytes in size having multimedia content specified for sequential presentation according to specified timing.

MMS messages are often delivered to a mobile communications device from a MMS Center, which is a telecommunications node that is typically operated by a telecommunications provider.

International patent application publication no. WO205/091615 naming Doyle et al. as inventors discloses a method of preparing MMS messages suitable for transmission over a mobile phone service from PowerPoint (trademark) multimedia presentations. The PowerPoint (trademark) multimedia presentations include presentation slides prepared on a personal computer (PC). The resulting MMS messages include a SMIL layout and animated GIF images representing presentation slides. The receiving mobile phone displays the MMS message such that each slide in the generated MMS presentation will advance automatically as specified within the generated SMIL layout. However, the method of Doyle et al. cannot prepare MMS messages from syndicated content, cannot prepare MMS messages in accordance with the media types supported by specific mobile devices, cannot prepare MMS messages for delivery at desired times pre-determined by users, cannot prepare MMS messages for delivery in response to the occurrence of desired events pre-determined by users, and cannot prepare MMS messages excluding previously delivered information for increased transmission efficiency, for example.

### SUMMARY

The above shortcomings may be addressed by providing, in accordance with one aspect of the invention, a method of producing a presentation message for a mobile device, the method comprising: retrieving syndicated content from a content source; and generating from the syndicated content the presentation message for sequentially presenting on the mobile device one or more content items of the syndicated content.

Retrieving the syndicated content from a content source may involve retrieving the syndicated content from the content source in accordance with a configuration parameter. Retrieving the syndicated content from a content source may involve retrieving the syndicated content from the content source in accordance with a configuration parameter selected from the group consisting of a user selection of a web feed, an invocation parameter and a periodicity parameter. Retrieving the syndicated content from a content source may involve retrieving the syndicated content from the content source in accordance with a user selection of a web feed. Retrieving the syndicated content from a content source may involve retrieving the syndicated content from the content source in accordance with an invocation parameter. Retrieving the syndicated content from a content source may involve retrieving the syndicated content from the content source in accordance with a periodicity parameter. Retrieving the syndicated content from the content source may involve determining whether a current time is equal to or past a time value of the invocation parameter. Retrieving the syndicated content from the content source may involve determining whether an event value of the invocation parameter has occurred. Retrieving the syndicated content from a content source may involve retrieving the syndicated content from the content source when a current time is equal to or past the time value of the invocation parameter. Retrieving the syndicated content from a content source may involve retrieving the syndicated content from the content source upon the occurrence of an event associated with the event value of the invocation parameter. Retrieving the syndicated content from a content source may involve retrieving a plurality of web feeds from one or more of the content sources.

Generating from the syndicated content the presentation message for sequentially presenting on the mobile device one or more content items of the syndicated content may involve selecting a content item of the one or more content items. Selecting the content item of the one or more content items may involve selecting the content item in accordance with an item reference associated with the syndicated content, wherein the item reference identifies the content item. Selecting the content item of the one or more content items may involve selecting the content item in accordance with a configuration parameter selected from the group consisting of a maximum content item size parameter and a non-redundancy parameter.

Generating from the syndicated content the presentation message for sequentially presenting on the mobile device one or more content items of the syndicated content may involve determining whether the content item has been used in generating a previous presentation message transmitted for delivery to the mobile device. Generating from the syndicated content the presentation message for sequentially presenting on the mobile device one or more content items of the syndicated content may involve determining whether a transmission flag associated with the content item is set to indicate previous use. Generating from the syndicated content the presentation message for sequentially presenting on the mobile device one or more content items of the syndicated content may involve determining whether a transmission flag associated with the item reference is set to indicate previous use.

Generating from the syndicated content the presentation message for sequentially presenting on the mobile device one or more content items of the syndicated content may involve converting the content item to a presentation object. Generating from the syndicated content the presentation message for sequentially presenting on the mobile device one or more content items of the syndicated content may involve converting the content item to a presentation object in accordance with a configuration parameter. Converting the content item to a presentation object may involve converting the content item to the presentation object in accordance with a configuration parameter selected from the group consisting of a supported media types parameter, a display dimensions parameter and a maximum presentation size parameter. Generating from the syndicated content the presentation message for sequentially presenting on the mobile device one or more content items of the syndicated content may involve converting the content item to a presentation object in accordance with a supported media types parameter.

Generating from the syndicated content the presentation message for sequentially presenting on the mobile device one or more content items of the syndicated content may involve assembling the presentation object into the presentation message. Assembling the presentation object into the presentation message may involve assembling the presentation object into the presentation message in accordance with a configuration parameter. Assembling the presentation object into the presentation message may involve assembling the presentation object into the presentation message in accordance with a configuration parameter selected from the group consisting of a supported media types parameter, a display dimensions parameter, a maximum presentation message size parameter, and a presentation parameter. The presentation parameter may be selected from the group consisting of a maximum number of presentation objects parameter and a service parameter. Assembling the presentation object into the presentation message may involve assembling the presentation object and one or more other presentation objects associated with the syndicated content into the presentation message. Assembling the presentation object into the presentation message may involve assembling the presentation object and one or more other presentation objects associated with one or more web feeds retrieved from one or more content sources into the presentation message.

The method may involve delivering the presentation message. Delivering the presentation message may involve transmitting the presentation message to a multimedia messaging service center for delivery to the mobile device. Delivering the presentation message may involve setting the transmission flag to indicate previous use. Delivering the presentation message may involve setting the transmission flag to indicate previous use of the content item associated with the item reference. Delivering the presentation message may involve storing the transmission flag in a database.

The method may involve receiving from the mobile device one or more configuration parameters for use in producing the presentation message for delivery to the mobile device. The method may involve obtaining one or more configuration parameters in response to receiving a communication originating from the mobile device. Obtaining one or more configuration parameters in response to receiving the communication originating from the mobile device may involve receiving user input. The method may involve storing the one or more configuration parameters in a database.

The method may involve receiving as user input a user selection of the syndicated content. Receiving as user input a selection of the syndicated content may involve receiving from the mobile device a user selection of a web feed. The method may involve storing the user selection in a database. The method may involve presenting on the mobile device a list of one or more web feeds associated with one or more content sources and available for selection by the user. The method may involve receiving as user input an invocation time. The method may involve storing in the database a time value of an invocation parameter associated with the invocation time. The method may involve receiving from the mobile device a device parameter selected from the group consisting of a supported media types parameter, a display dimensions parameter and a maximum presentation message size parameter. Receiving from the mobile device a device parameter selected from the group consisting of a supported media types parameter, a display dimensions parameter and a maximum presentation message size parameter may involve receiving the device parameter from the mobile device via a WAP gateway of a telecommunications infrastructure. The method may involve determining a presentation parameter. Determining the presentation parameter may involve receiving as user input from the mobile device the presentation parameter.

In accordance with another aspect of the invention, there is provided a computer program product comprising computer-executable instructions embodied in a computer-readable medium for performing one or more methods of the present invention.

In accordance with another aspect of the invention, there is provided a system for producing a presentation message for a mobile device, the system comprising a database; a configuration component for determining a plurality of configuration parameters and storing the plurality of configuration parameters in the database; a retrieval component for retrieving syndicated content; and a message generating component for generating from the syndicated content the presentation message for sequentially presenting on the mobile device one or more content items of the syndicated content.

In accordance with another aspect of the invention, there is provided a system for producing a presentation message for a mobile device, the system comprising configuration means for determining a plurality of configuration parameters; database means for storing the plurality of configuration parameters; retrieval means for retrieving syndicated content; and message generating means for generating from the syndicated content the presentation message for sequentially presenting on the mobile device one or more content items of the syndicated content.

Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example only embodiments of the invention:

FIG. 1 is a block diagram of a system for producing a presentation message for a mobile device according to a first embodiment of the invention, showing an environment of the system;

FIG. 2 is a flow diagram of a method of the system shown in FIG. 1 of producing a presentation message for a mobile device;

FIG. 3 is a flow diagram of a method of determining and storing a plurality of configuration parameters of the system shown in FIG. 1;

FIG. 4 is a flow diagram of an exemplary method of performing the step shown in FIG. 2 of retrieving syndicated content from a content source; and

FIG. 5 is a flow diagram of an exemplary method of performing the step shown in FIG. 2 of generating a presentation message for sequentially presenting on a mobile device on or more content items of the syndicated content.

### DETAILED DESCRIPTION

A system for producing a presentation message for a mobile device includes: configuration means for determining a plurality of configuration parameters; database means for storing the plurality of configuration parameters; retrieval means for retrieving syndicated content; and message generating means for generating from the syndicated content the presentation message for sequentially presenting on the mobile device one or more content items of the syndicated content.

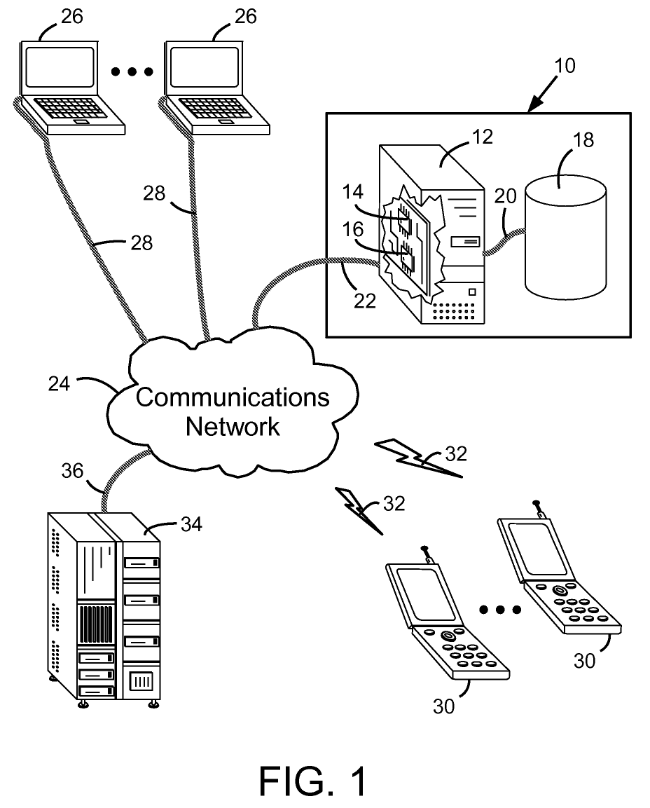

Referring to FIG. 1, the system according to a first embodiment of the invention is shown generally at 10. The system 10 is operable to perform methods of the present invention, including methods of retrieving syndicated content from a content source and generating a presentation message for sequentially presenting on a mobile device one or more content items of the syndicated content.

Syndicated content can include any information or data available through syndication, including being available as all or part of a feed such as a web feed. Syndicated content can be obtained from any content source, including a web feed publisher or other information publisher, or any source that has obtained the syndicated content from an information publisher, for example. Examples of content sources include news websites, weblogs, podcasts, any source of periodically or intermittently updated information, and any combination thereof.

Typically, syndicated content is published in a standard syndication format such as RSS (e.g. Really Simple Syndication) or ATOM. However, the scope of the present invention is not limited to the retrieval of syndicated content in any particular format.

The system 10 includes a server 12 having a processing circuit, such as the processor 14 shown in FIG. 1, and a memory circuit 16. The system 10 also includes a database 18, which is shown in FIG. 1 as being connected to the server 12 by a database connection 20.

The server 12 may be any computing device such as a general purpose computer, microcomputer, minicomputer, mainframe computer, distributed networked computer, functionally equivalent discrete hardware components and any combination thereof, for example.

The processor 14 is typically a processing circuit that includes one or more circuit units, such as a central processing unit (CPU), digital signal processor (DSP), embedded processor, etc., and any combination thereof operating independently or in parallel, including possibly operating redundantly. The processor 14 may be implemented by one or more integrated circuits (IC), including being implemented by a monolithic integrated circuit (MIC), an Application Specific Integrated Circuit (ASIC), a Field Programmable Gate Array (FPGA), etc. or any combination thereof. Additionally or alternatively, the processor 14 may be implemented as a programmable logic controller (PLC), for example. The processor 14 may include circuitry for storing memory, such as digital data, and may comprise the memory circuit 16 or be in wired communication with the memory circuit 16, for example.

Typically, the memory circuit 16 and the database 18 are each all or part of a digital electronic integrated circuit, and may each be implemented by one or more integrated circuits (IC), including being implemented by a single monolithic integrated circuit (MIC). The memory circuit 16 and the database 18 may be implemented as Read-Only Memory (ROM), Programmable Read-Only Memory (PROM), Erasable Programmable Read-Only Memory (EPROM) or Electrically Erasable Programmable Read-Only Memory (EEPROM), flash memory, one or more flash drives, universal serial bus (USB) connected memory units, magnetic storage, optical storage, magneto-optical storage, and any combination thereof, for example. The memory circuit 16 and the database 18 may be operable to store memory as volatile memory, non-volatile memory, dynamic memory, and any combination thereof.

The database 18 may be implemented as part of the processor 14, the memory circuit 16, or may be implemented separately from the server 12 as shown in FIG. 1. The database 18 typically functions to store information, typically in the form of recordable and retrievable data for use within or by the system 10, including data records stored in association with other data records.

FIG. 1 shows an exemplary communications environment of the system 10. In the first embodiment, the server 12 is connected by a server connection 22 to a network such as the communications network 24 shown in FIG. 1. The communications network 24 may include any number of communications nodes, and may include all or part of a telecommunications infrastructure, all or part of a data communications infrastructure, all or part of the Internet, and any combination thereof for example. In some embodiments (not shown), the database 18 is connected to the server 12 through the communications network 24 in addition or in the alternative to the database connection 20.

The system 10 is typically operable to run any one or more operating systems, including time operating systems such as Windows, UNIX, Linux, etc., and real-time operating systems such as WinCE, Symbian, OSE, Embedded LINUX, etc., and any combination thereof. The system 10 may be operable to implement multi-tasking methods involving multiple threads of executable code, for example.

Source devices 26 are shown in the exemplary arrangement of FIG. 1 as being connected via source connections 28 to the communications network 24 for making syndicated content available for transmission and retrieval. In general, the system 10 is operable to obtain syndicated content, including receiving information feeds, from any number of content sources including web feed sources. In the first embodiment, the system 10 is operable to retrieve syndicated content transmitted through the communications network 24 from any of the source devices 26. While FIG. 1 shows exemplary illustrations of source devices 26 as laptop computers, the system 10 is not limited by the type of a source device 26 and is operable to retrieve syndicated content from any type of electronic device operable to transmit syndicated content across the communications network 24. For example, one or more source devices 26 may be one or more web server computers, including industry standard web servers.

Communications devices such as the mobile telephones 30 of users (not shown) are shown in the exemplary arrangement of FIG. 1 as being connected by wireless connections 32 to the communications network 24. In the first embodiment, the system 10 is operable to produce presentation messages for delivery to a communications device such as any of the mobile telephones 30 shown in FIG. 1. A person of ordinary skill in the art will appreciate that the communications devices are not restricted to the mobile telephones 30 shown in FIG. 1, but can be any number of devices for receiving communications such as cellular telephones, satellite telephones, personal digital assistants, pagers, wireless communications devices, or similar devices. In the first embodiment, the system 10 is operable to effect communications with the mobile telephones 30. In some embodiments, the system 10 is operable to effect communications with the mobile telephones 30 directly from the server 12 to a given mobile telephone 30 via the server connection 22, at least a portion of the communications network 24, and the wireless connection 32.

Still referring to FIG. 1, the system 10 in the first embodiment is operable to effect communications with the telecommunications infrastructure 34, which is shown in FIG. 1 connected to the communications network 24 via a telecommunications connection 36. The telecommunications infrastructure 34 is typically operated by a telecommunications provider, and may include Multimedia Messaging Service (MMS) equipment for delivering MMS messages from the system 10 to the mobile telephones 30 and a WAP (Wireless Application Protocol) gateway for transmitting to the system 10 communications, including requests, received from the mobile telephones 30. For ease of illustration, the telecommunications infrastructure 34 is shown in FIG. 1 as being separate from the communications network 24. However, the telecommunications infrastructure 34 may also be considered to form part of the communications network 24.

The system 10 is operable in the first embodiment to transmit a given message from the server 12 to the telecommunications infrastructure 34 via the server connection 22, at least a portion of the communications network 24 and the telecommunications connection 36. Upon receiving the given message, the telecommunications infrastructure 34 normally forwards it (or a variant or derived message thereof after possible processing by the telecommunications infrastructure 34) to a specifiable mobile telephone 30 via the telecommunications connection 36, at least a portion of the communications network 24, and the wireless connection 32. The portion of the communications network 24 used for transmitting communications between the system 10 and the telecommunications infrastructure 34 and the portion of the communications network 24 used for transmitting communications between the telecommunications infrastructure 34 and the mobile telephones 30 may be identical, partly overlapping or completely separate. Thus, in at least normal operation of the environment in which the system 10 operates, transmitting a given message to the telecommunications infrastructure 34 results in the delivery of the given message to a specified mobile telephone 30.

While the database connection 20, server connection 22, source connection 28 and telecommunications connection 36 are shown in FIG. 1 as wired connections, these connections 20, 22, 28 and 36 or portions thereof may be any wired or wireless connection, including a copper wire link, a coaxial cable link, a fiber-optic transmission link, a radio link, a cellular telephone link, a satellite link, a line-of-sight free optical link, and any combination thereof, for example.

### Method of Operation

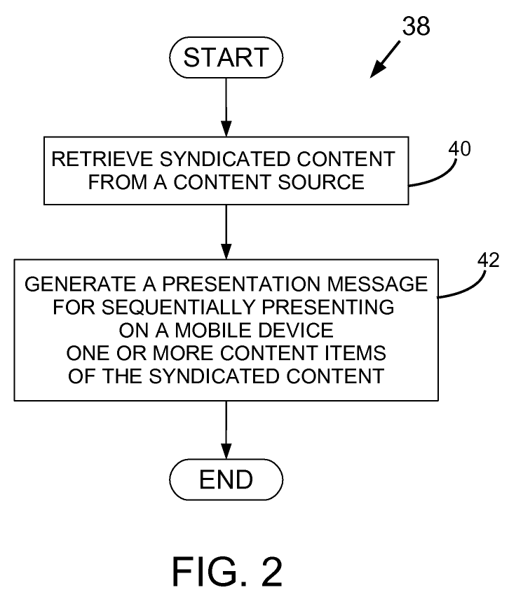

Referring to FIG. 2, the memory circuit 16 in accordance with the first embodiment of the invention contains blocks of code comprising computer executable instructions for directing the processor 14 to perform the steps of a method shown generally at 38. Additionally or alternatively, such blocks of code may form part of a computer program product comprising computer executable instructions embodied in a signal bearing medium, which may be a recordable computer readable medium or a signal transmission type medium, for example.

When electrical power is being supplied to the processor 14 and the memory circuit 16, the processor 14 is directed to begin executing the instructions of block 40. Block 40 directs the processor 14 to retrieve syndicated content from a content source. In the first embodiment, the system 10 (FIG. 1) is operable to cause the processor 14 to retrieve the syndicated content in the form of a web feed from the content source, which may be an information publisher or a source having obtained the web feed from an information publisher, for example.

Block 42 then directs the processor 14 to generate a presentation message for sequentially presenting on a mobile device one or more content items of the syndicated content. In the first embodiment, the system 10 is operable to cause the processor 14 to generate a presentation message for sequentially presenting on a given mobile telephone 30 one or more content items (described further below) of the syndicated content. As described in further detail below, the system 10 in at least some embodiments is operable to generate the presentation message by converting the one or more content items to presentation objects and assembling the presentation objects into the presentation message for delivery to the mobile telephone 30.

After block 42 has been executed, the processor 14 is then directed to end the method 38.

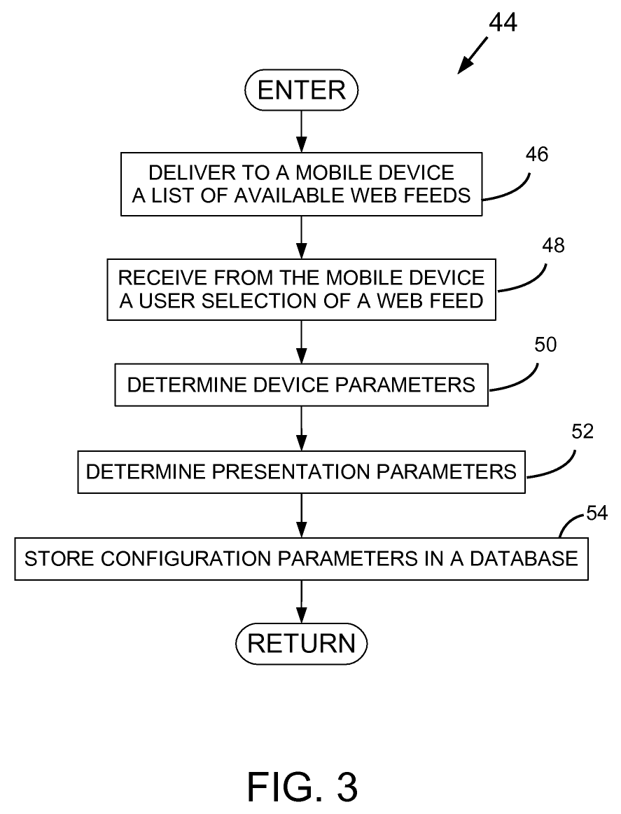

Referring to FIG. 3, the system 10 in the first embodiment is operable to determine and store configuration parameters for use in executing methods of the system 10. Such configuration parameters typically include user selections of web feeds, device parameters and presentation parameters. An exemplary method of determining and storing configuration parameters of the system 10 is shown generally in FIG. 3 at 44. The method 44 is preferably executed for a given mobile telephone 30 and associated user at any time before a given presentation message is delivered to the given mobile telephone 30. For example, a user (not shown) may use the given mobile telephone 30, or other device useable for communicating with the system 10 via the communications network 24, to log into a configuration feature of the system 10 such that the system 10 operates to determine one or more of the configuration parameters before delivering the presentation message to the given mobile telephone 30. The system 10 is operable then to make use of the configuration parameters in generating the presentation message for delivery to the given mobile telephone 30.

Block 46 of the method 44 directs the processor 14 to deliver to a mobile device, such as the given mobile telephone 30, a list of available web feeds. In general, the system 10 is operable to make available to any number of mobile devices one or more lists of syndicated content, each of which may include any number of available web feeds. In the first embodiment, the system 10 is operable to deliver the list of web feeds to the given mobile telephone 30 via the communications network 24. The list may be provided in any suitable format, including providing the list as a SMS message to the mobile telephone 30, providing the list as a MMS message via the telecommunications infrastructure 34, making the list available for viewing on the mobile telephone 30 via a web page of a system 10 website, and any combination thereof, for example. The system 10 typically stores the list of available web feeds in the database 18 and retrieves the list of web feeds from the database 18 for delivery of the list to the given mobile telephone 30. In some embodiments, the system 10 is operable to cause the processor 14 to effect delivery of the list of available web feeds in response to a reply received from the mobile telephone 30 in reply to a message, such as a SMS or MMS message, for example. In some embodiments, the system 10 operates to deliver the list of available web feeds only after the successful completion by the user of a login or similar process. The system 10 is operable in the first embodiment to provide other information, such as informational or promotional material, with the list of available web feeds.

Block 48 directs the processor 14 to receive from the mobile device a user selection of a web feed. In the first embodiment, the system 10 is operable to receive as user input from the given mobile telephone 30 that user's selection of a web feed listed on the list of available web feeds. For example, the system 10 is operable to receive from the given mobile telephone 30 a URL (Uniform Resource Locator), name or other identifying indicator associated with a web feed source that had been typed in by a user for transmission to the system 10. Additionally or alternatively, receiving a user selection of a web feed may involve receiving an indication, such as a URL or similar, of a web feed source in response to a user selecting a “Send Me” type hyperlink button presented at a website of the web feed source, for example. The user selection of a hyperlink button may be received by the system 10 from any source, including receiving the user selection of the hyperlink button from the mobile telephone 30 that was employed to make such selection. The system 10 is preferably operable to determine the user selection of the web feed from the information contained within a hyperlink button received by the system 10.

In some embodiments, the execution of block 46 to deliver to the given mobile telephone 30 a list of available web feeds is optionally executed or not executed at all. In such embodiments, the system 10 is operable to receive a communication originating from the given mobile telephone 30, such as a communication initiated by the user selection of a hyperlink button indicating a requested web feed, and to obtain the user selection of the requested web feed from the received communication, including possibly from header information associated with the received communication.

In some embodiments, the system 10 is operable to receive a user selection of a web feed or other syndicated content not listed on the list of available web feeds as a syndicated content request, for example. In the first embodiment, the system 10 is operable to fulfill such request, provided such request is for a valid and available web feed. Typically, the user selection is received by the system 10 from the given mobile telephone 30 via the communications network 24. In some embodiments, the user selection is received via the telecommunications infrastructure 34, including via the WAP gateway of the telecommunications infrastructure 34. Additionally or alternatively, the user selection may be received via a SMS message originating from the given mobile telephone 30.

Block 50 directs the processor 14 to determine device parameters. In the first embodiment, the system 10 is operable to determine device parameters of the given mobile telephone 30, including a supported media types parameter, a display dimensions parameter, a maximum presentation size parameter, other related parameters, and any combination thereof.

The supported media types parameter indicates in the first embodiment the types of media (e.g. ASCII text, UTF-8 encoded text, GIF images, JPG images, PNG images, MPG videos, 3GPP videos, etc.) supported by the given mobile telephone 30, the mobile telephone 30 generally being capable of displaying supported media types of content.

The display dimensions parameter indicates in the first embodiment a size of the display of the given mobile telephone 30.

The maximum presentation size parameter indicates in the first embodiment the maximum data size, which may be measured in bytes or multiples thereof for example, of a message, such as a MMS message, that can be received and processed by the given mobile telephone 30.

In the first embodiment, the system 10 is operable to produce a presentation message for delivery to a mobile device in accordance with the media types supported by the mobile device, the display dimensions of the mobile device, and such that the data size of the presentation message does not exceed the maximum size of a message that can be received by the mobile device.

In some embodiments, the system 10 is operable to specify the value of one or more device parameters, such as where such device parameter value is not obtained from a given mobile telephone 30 itself or from its user as user input or would otherwise exceed a system 10 maximum value or allowable range of values for such device parameter value. In such embodiments, the system 10 is operable to specify the value of such device parameters in accordance with associated system 10 default values.

In the first embodiment, the system 10 is operable to determine the device parameters from header information associated with communications received from the given mobile telephone 30, including determining the device parameters from a UserAgentProfile parameter. In the first embodiment, the system 10 is operable to receive the UserAgentProfile as part of a request, or response to a request, received from the given mobile telephone 30, which request or response is typically received by the system 10 via the wireless connection 32, and may be received via the WAP gateway of the telecommunications infrastructure 34. For example, the UserAgentProfile may be transmitted from the given mobile telephone 30 when transmitting the user selection of the web feed (block 48). In some embodiments, the system 10 is operable to receive the UserAgentProfile by receiving a response from the given mobile telephone 30 to a request delivered to the given mobile telephone 30. Additionally or alternatively, the system 10 in some embodiments is operable to separately receive each of the configuration parameters in separate communications.

In some embodiments, the system 10 is operable to update one or more device parameters when a user changes from one mobile telephone 30 to a new mobile telephone 30, including doing so without requiring the user to create a new user account for login purposes.

In some embodiments, the system 10 is operable to accept a request that a system 10 service be provided to a given mobile telephone 30, where such request is received from a device other than the given mobile telephone 30. In such embodiments, the UserAgentProfile parameter associated with the given mobile telephone 30 typically cannot be obtained directly from such other device. In circumstances where the device parameters have not been previously determined and the UserAgentProfile is not available, the system 10 is operable in the first embodiment to determine the device parameters in accordance with system 10 default values. Additionally or alternatively, the system 10 is operable in at least some embodiments to determine the device parameters in response to user input received from such other device. For example, such user input may include an indication of the make and model of the given mobile telephone 30. In some embodiments, the system 10 is operable to provide a list of makes and models of mobile telephones 30 for selection by the user of a specific make and model. In variations of embodiments, such list may include a text format list, graphic images showing models of mobile telephones 30, and any combination thereof for example.

Block 52 directs the processor 14 to determine one or more presentation parameters. Presentation parameters typically indicate features, including desired features and user-specifiable features, of the presentation message that are not device dependent, and may or may not be specific to a given mobile telephone 30. For example, presentation parameters in at least some embodiments include an invocation parameter, a periodicity parameter, an object display duration parameter, a maximum number of presentation objects parameter, a maximum content item size parameter, a non-redundancy parameter, service parameters, other related parameters, and any combination thereof.

In the first embodiment, the value of the invocation parameter represents a condition, such as an event or a time or times, for which the user would like to receive the presentation message generated on the basis of the user selected web feed received by executing block 48. For example, the value of the invocation parameter may indicate one or more days of the week, including one or more groups of days of the week (e.g. weekdays, non-holiday weekdays, weekend days, weekend days and holidays, etc.), and one or more user specified times during such indicated days. Each specified time may be indicated by hours and minutes (e.g. 7:00 a.m., 7:12 p.m., 19:45, etc.), for example. In the first embodiment, the system 10 is operable to permit a variety of different times to be specified in association with a variety of different days or groups of days. For example, the value of the invocation parameter may include the invocation times of 7:00 a.m. and 4:30 p.m. in association with weekdays, the invocation times of 8:50 a.m. and 6:30 p.m. in association with Saturday, and the invocation time of 11:00 a.m. in association with Sunday, for example.

Additionally or alternatively, the condition represented by the value of the invocation parameter includes in some embodiments one or more events. For example, the value of the invocation parameter may include an indication that a presentation message be generated and delivered to the user's mobile telephone 30 at or after each occurrence of a new score associated with one or more sports events being published by a specifiable content source. In this example, a user may specify that a new presentation message be delivered when an updated score for a selected sports match becomes available or when a new completed game score for each match in a tournament or championship series becomes available, for example.

The value of the periodicity parameter in the first embodiment indicates a numeric periodicity in association with one or more invocation times. For example, if the value of the invocation parameter includes the days specified as Tuesday and Friday, and the specified times are 7:00 and 19:00, then a periodicity of 2 would result in invocation of presentation message generation the Tuesday and Friday at 7:00 and 19:00 hours of every second week, and a periodicity of 4 would result in invocation every fourth week, or once per month. Other times and arrangements can be specified by the periodicity parameter and are within the scope contemplated by the present invention.

The object display duration parameter indicates the duration of time a given presentation object of the presentation message is to be displayed on a given mobile telephone 30. In the first embodiment, this object display duration parameter is defined by the system 10 as a fixed value for all presentation objects of all presentation messages for all mobile telephones 30, and thus block 52 can be optionally executed in respect of this object display duration parameter. In some embodiments, however, the system 10 is operable to determine a value of the object display duration parameter for a given presentation object in accordance with the type of information contained within that given presentation object. For example, a presentation object containing a large amount of text may be displayed for a longer time than a presentation object containing less text, thereby advantageously providing a greater amount of time for a user to read the increased amount of text. In such embodiments, the value of the object display duration parameter may be determined separately for each presentation object, specified for groups of presentation objects within a given presentation message, specified for all presentation objects of a given presentation message, specified for the presentation objects of all presentation messages, and any combination thereof, for example.

The maximum number of presentation objects parameter indicates the maximum number of presentation objects permitted to be included within one presentation message. In the first embodiment, the value of the maximum number of presentation objects parameter is defined by the system 10 as a fixed value for all presentation objects of all presentation messages in respect of all mobile telephones 30, thus block 52 can be optionally executed in respect of this parameter. However, in general, the value of the maximum number of presentation objects parameter may be determined separately for each presentation message and/or type thereof and separately in respect of each mobile telephone 30 or group thereof, for example.

The maximum content item size parameter indicates a maximum size (e.g. in bytes or a multiple thereof) of a content item selected for conversion to a presentation object. In the first embodiment, the value of the maximum content item size parameter is defined by the system 10 as a fixed value for all content items of all web feeds in respect of all mobile telephones 30, thus block 52 can be optionally executed in respect of this parameter. However, in general, the value of the maximum content item size parameter may be determined separately for each web feed and/or type thereof and separately in respect of each mobile telephone 30 or group thereof, for example.

The non-redundancy parameter indicates whether a content item that has previously been processed by converting the content item to a presentation object and assembling the presentation object into a presentation message delivered to a given mobile telephone 30 should be processed again as it was previously processed or excluded from processing such that presentation messages generated and delivered by the system 10 do not include previously delivered or otherwise redundant information. In the first embodiment, the non-redundancy parameter is set by the system 10 to exclude redundancies in all presentation messages for all mobile telephones 30. Avoiding redundancy in presentation messages advantageously improves the processing efficiency of the system 10 and, additionally or alternatively, advantageously reduces the size of presentation messages being delivered to mobile telephones 30, which can reduce data transfer costs for users. In some embodiments, the value of the non-redundancy parameter for a given mobile telephone 30 is determined from user input received in association with the given mobile telephone 30.

Service parameters are employed by the system 10 in the first embodiment to permit the inclusion into presentation messages of additional information, which is typically independent of the content items associated with the presentation messages. A given service parameter in the first embodiment includes the additional information to be included in a given presentation message, or groups of presentation messages; and an associated indication of the location or locations within the given presentation message(s) at which the additional information is to be added. The additional information may include instructional information such as instructions related to the use of services offered by the system 10, including instructions on how to upgrade or unsubscribe to a system 10 service. Additionally or alternatively, the additional information may include promotional information, including advertisements, for example. Instructional information may be injected into or otherwise added to a presentation message at or near its end, while promotional information may be injected into or otherwise added to a presentation message at or near its beginning, for example.

In some embodiments, one or more configuration parameters are user specifiable such that determining such configuration parameters involves receiving indications of such configuration parameters as user input and may involve prompting users of the mobile telephones 30 for their respective selections of indications of such configuration parameters and/or presenting a list of configuration parameters on the mobile telephones 30 or other communications devices, for example. In some embodiments, the system 10 is operable to determine the values of one or more configuration parameters in accordance with system 10 default values, including overriding values indicated by a UserAgentProfile, selected by a user, or both indicated by a UserAgentProfile and selected by a user. In some embodiments, one or more configuration parameters are determined in accordance with system 10 default values such that one or more steps of blocks 50 and 52 are optionally executed or not executed at all. In some embodiments, one or more configuration parameters are stored in the database for later retrieval and use when generating a given presentation message. In some embodiments, the system 10 is operable to generate a given presentation message such that a user of the given mobile telephone 30 is permitted to update or otherwise select indications of one or more configuration parameters and the system 10 is operable to modify the given presentation message accordingly. For example, one or more steps of the blocks 50 and 52 may be performed during execution of the method 44 (as shown in FIG. 3); during the execution of other methods of the system 10; before, during or after the presentation of a given presentation message on a given mobile telephone 30; and any combination thereof, for example.

Block 54 directs the processor 14 to store configuration parameters in a database. In the first embodiment, the system 10 is operable to store configuration parameters in the database 18 (FIG. 1). For ease of illustration, FIG. 3 shows block 54 being executed after the execution of blocks 46 to 52. However, each configuration parameter can, in variations of the present invention, be stored at any time after being received, determined or otherwise obtained by the system 10, including being stored immediately after being obtained.

While FIG. 3 shows blocks 46 to 54 in a specific order, in general the steps of the method 44 can be executed in any order, and each step may be repeated as may be suitable for operation of the system 10. In typical operation of the system 10 for a given mobile telephone 30, at least some steps of the method 44 are executed prior to executing the method 38 (FIG. 2).

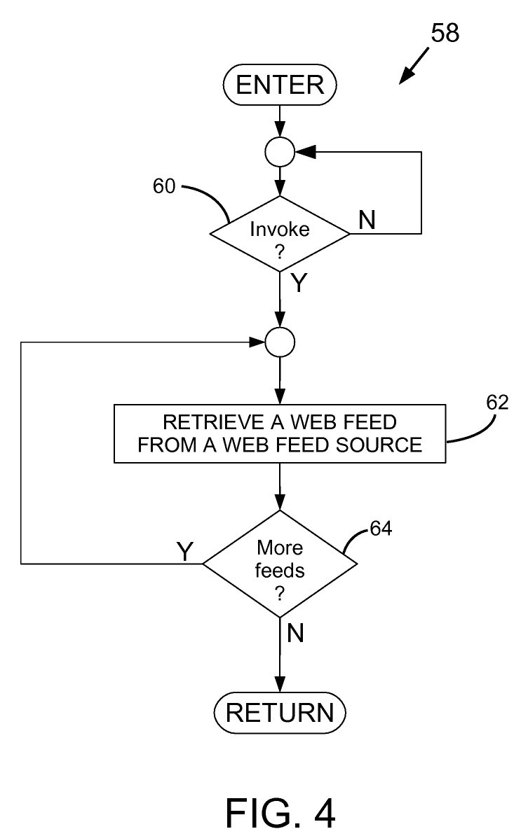

Referring to FIG. 4, an exemplary method of directing the processor 14 to perform steps of block 40 (FIG. 2) is shown generally at 58.

Block 60 of the method 58 directs the processor 14 to determine whether invocation should occur. In the first embodiment, the system 10 is operable to determine whether to invoke the retrieval of one or more web feeds or other syndicated content. In typical operation of the system 10, determining whether to invoke involves determining whether the current time is equal to or past a time value of the invocation parameter determined by block 52 (FIG. 3), whether the event defined by an event value of the invocation parameter has occurred, or both whether the time and event values of the invocation parameter have occurred. In some embodiments, determining whether to invoke involves determining whether the current time is equal to or after a specifiable time prior to a time value of the invocation parameter and within a specifiable duration before that time value, which duration may be an estimate of the processing time required for generating and delivering a presentation message. Determining the time value of an invocation parameter typically involves taking into account the numeric value of any associated periodicity parameter, such as by defining one or more invocation parameters in response to any associated periodicity parameter and/or calculating one or more time values of an invocation parameter on the basis of any associated periodicity parameter.

If the processor 14 determines not to invoke, then the process returns to the beginning of the method 58 for re-execution of block 60. In the first embodiment, the system 10 is operable to wait for the appropriate invocation time or event. For ease of illustration, FIG. 4 shows that the processor 14 does nothing other than repetitively execute block 60 until the appropriate invocation time or event occurs. However, the system 10 in variations of the present invention is operable to perform other tasks while waiting for the appropriate invocation time or event to occur. In some embodiments, the system 10 is operable to periodically compare the current time with the time values of invocation parameters for any number of mobile telephones 30, and operable to periodically check for the occurrence of events defined by event values of invocation parameters for any number of mobile telephones 30. In variations of embodiments, the processor 12 is operable to generate and/or receive interrupts indicating an appropriate invocation time or event has occurred, and is operable to respond to any such interrupts.

If the processor 14 determines to invoke, the processor 14 is directed to execute block 62, which directs the processor 14 to retrieve a web feed from a web feed source. In general, the system 10 is operable in the first embodiment to retrieve any number or amount of syndicated content from any number of content sources. In the first embodiment, the system 10 is operable to retrieve the web feeds in accordance with the user selection received by block 48. In some embodiments, all the user selected web feeds from a given web feed source are retrieved during a given execution of block 62. In some instances, the web feed or web feeds being retrieved are formatted in accordance with the RSS format or the ATOM syndication format. However, operation of the system 10 is not limited to these exemplary feed formats.

After block 62 has been executed, the processor 14 is directed to execute block 64, which directs the processor 14 to determine whether there are more web feeds. In the first embodiment, the system 10 is operable to determine whether there are web feeds or other syndicated content indicated by the user selection received by block 48 (FIG. 3), apart from the web feeds that have been already retrieved by block 62.

If the processor 14 determines that there are more web feeds, the processor 14 is directed to block 62 for the retrieval of another web feed, including possibly retrieving another web feed from a different web feed source.

If the processor 14 determines that there are no more web feeds for retrieval, the processor 14 is then directed to return to the method 38 at block 42 (FIG. 2).

While FIG. 4 shows the retrieval of one web feed at a time, the system 10 is operable in some embodiments to retrieve more than one web feed simultaneously or within a single transmission, and is operable in some embodiments to receive a plurality of web feeds from one or more web feed sources within a single transmission, for example.

Still referring to FIG. 4 and with reference to the first embodiment, the system 10 is operable to execute blocks 62 to 64 until one or more, including possibly all, the web feeds required to generate (e.g. in accordance with block 42 of FIG. 2) one or more, including possibly all, presentation messages associated with one or more, including possibly all, mobile telephones 30 for which invocation occurs in accordance with block 60.

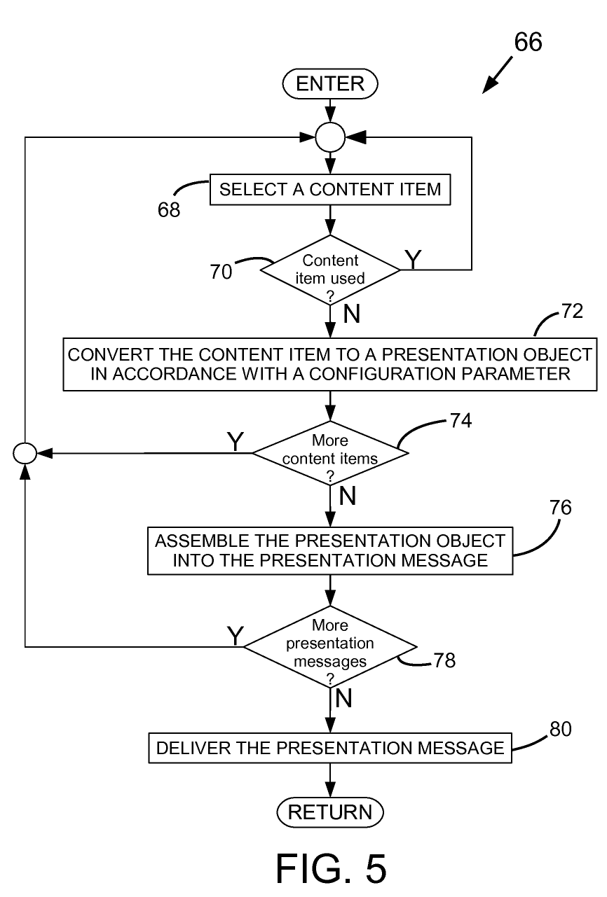

Referring to FIG. 5, an exemplary method for directing the processor 14 to perform steps of block 42 (FIG. 2) in respect of a given mobile telephone 30 is shown generally at 66.

Method 66 begins execution at block 68, which directs the processor 14 to select a content item. Such content item may be a content item of syndicated content retrieved from a content source by block 40 (FIG. 2), for example. In the first embodiment, selecting a content item involves selecting the content item as a subset of the syndicated content in accordance with an item reference. Such item reference may take any form capable of referencing the content of a given content item, and may include a URL, a data pointer, an item identifier such as start and end delimiters defining the content item within retrieved syndicated content, other related indications, and any combination thereof for example. In some embodiments, selecting a content item involves defining start and end points of an item in accordance with configuration parameters associated with the given mobile telephone 30 or other parameters of the system 10, such as default parameters, for example. Such defined start and end points may be determined by a desired size, such as measured in bytes, of a content item, including being determined by a fixed and/or predetermined size. For example, such defined start and end points may be determined in accordance with a value of the maximum content item size parameter.

Content items may be ordered such that executing the method 66 begins by executing block 68 to select a first content item, and subsequent executions of block 68 cause the system 10 to select a next content item in accordance with an ordering scheme for the content items.

After block 68 is executed, the processor 14 is directed to execute block 70, which directs the processor 14 to determine whether the content item selected by block 68 has already been used. In the first embodiment, the system 10 is operable to determine whether the content item selected by block 68 has already been used in a method of the system 10 to generate a presentation message previously transmitted for delivery to the given mobile telephone 30. In the first embodiment, determining whether the content item has already been used involves determining whether a transmission flag is set to indicate previous use. In some embodiments, the transmission flag is associated with an item reference identifying the content item, such that determining whether the content item has already been used involves determining whether the transmission flag associated with the item reference of the content item is set to indicate previous use.

If the content item has already been used, then the processor 14 is directed to execute block 68 to select a next content item. In this manner, previously used content items are advantageously excluded from further processing of the method 66. Excluding previously used content items from such further processing advantageously improves the processing efficiency of the system 10. Additionally or alternatively, excluding such content items advantageously reduces the size of the presentation messages being delivered to the given mobile telephone 30, which can reduce data transfer costs for the user.

If the content item has not already been used (including possibly having been updated or otherwise altered since a previous use), then the processor 14 is directed to execute block 72, which directs the processor 14 to convert the content item to a presentation object in accordance with a configuration parameter. In the first embodiment, the system 10 is operable to convert the content item from a web feed format, such as RSS or ATOM syndication format, to a presentation object, such as a slide or other object, suitable for inclusion in a presentation message. In typical operation of the first embodiment, such presentation message is a MMS message for sequential presentation of one or more presentation objects converted from one or more content items. In the first embodiment, the system 10 is operable to convert the content item into a presentation object that incorporates only supported media types in accordance with the supported media types parameter and that is not of such size as to cause a presentation message generated on the basis of the presentation object to exceed the value of its maximum presentation size parameter, if any. In some embodiments, the system 10 is operable to convert the content item into a presentation object that is compatible with the display dimensions parameter associated with the given mobile telephone 30, including by resizing a content item, presentation object, or both a content item and a presentation object, or portions thereof. Additionally or alternatively, the system 10 is operable in some embodiments to convert the content item into a presentation object that incorporates one or more presentation parameters for that presentation object, such as the object display duration parameter and/or a service parameter for example.

While blocks 68 to 72 shown in FIG. 5 accords with an exemplary embodiment of the invention, in some embodiments block 70 is optionally executed or not executed at all. For example, the system 10 is operable in the first embodiment to execute block 70 if the non-redundancy parameter is set to a first value, such as TRUE or binary one, and to not execute block 70 if the non-redundancy parameter is set to a second value, such as FALSE or binary zero. If block 70 is not executed, then all content items selected by executing block 68, whether already used or not, are presented for processing by block 72 as described herein above.

The iterative nature of the method 66 advantageously permits the content items of each web feed retrieved by block 62 (FIG. 4) to be converted to presentation objects by block 72 multiple times in accordance with different values of configuration parameters, such as when generating presentation messages associated with different mobile telephones 30 for which invocation occurs in accordance with block 60 (FIG. 4), without having to retrieve the same web feed multiple times. In some embodiments, however, a given web feed may be retrieved multiple times when used in generating different presentation messages associated with different mobile telephones 30 for which invocation occurs in accordance with block 60 (FIG. 4).

After block 72 is executed, the processor 14 is directed to execute block 74, which directs the processor 14 to determine whether there are more content items. If the processor 14 determines that there are more content items, the processor 14 is directed to execute block 68 to select a next content item. In the exemplary operation of the method 66 of FIG. 5, blocks 68, 70 and 72 are executed until there are no further content items for selection and conversion.

Still referring to FIG. 5 and with reference to the first embodiment, the system 10 is operable to select and convert one or more, including possibly all, content items required to generate one or more, including possibly all, presentation messages associated with one or more, including possibly all, mobile telephones 30 for which invocation occurs in accordance with block 60 (FIG. 4).

In some embodiments, however, the number of content items is limited to a specifiable maximum number of content items, including limiting the maximum number of content items selected for conversion such that any presentation message generated on the basis of such content items does not violate the maximum number of presentation objects parameter or other related parameter, including any default parameter of the system 10.

If the processor 14 determines that there are no more content items, then the processor 14 is directed to executed block 76, which directs the processor 14 to assemble the presentation object into the presentation message. Assembling the presentation object into the presentation message typically involves assembling all presentation objects converted from content items by block 72 into one presentation message. However, the system 10 is operable in some embodiments to assemble a subset of the presentation objects converted from content items by block 72 into one presentation message. For example, the system 10 is operable in some embodiments to assemble presentation objects into one or more presentation messages in which each such presentation message does not exceed the value of the maximum presentation size parameter determined by block 52 (FIG. 3). In the first embodiment, the system 10 is operable to assemble presentation objects into one or more presentation messages which do not contain more presentation objects than indicated by the value of the maximum number of presentation objects parameter associated with a given mobile telephone 30. In the first embodiment, the system 10 is operable to assemble presentation objects into one or more presentation messages that are compatible with the supported media types parameter associated with the given mobile telephone 30. In the first embodiment, the system 10 is operable to assemble presentation objects into one or more presentation messages that are compatible with the display dimensions parameter associated with the given mobile telephone 30, including by resizing a presentation object or portion thereof for example. Additionally or alternatively, the system 10 is operable in some embodiments to assemble presentation objects into one or more presentation messages that incorporate one or more presentation parameters associated with the one or more presentation messages, respectively, including assembling a presentation object into a presentation message in accordance with a value of the object display duration parameter and in accordance with one or more service parameters.

Executing block 76 preferably results in at least one presentation message that, when viewed on the given mobile telephone 30, causes the presentation objects converted from content items by block 72 to be sequentially displayed on the mobile telephone 30. Sequentially displaying presentation objects on a mobile telephone 30 may involve displaying each presentation object for a duration of time, specified by the object display duration parameter, in a sequence to form a slide presentation or similar other presentation message on the mobile telephone 30. In the first embodiment, the presentation message is a MMS message encoded in accordance with the MMS standard. However, in general, the presentation message may be produced in accordance with any standard for any format and encoded in any language suitable for the sequential display of presentation content.

In some embodiments, the order in which blocks 74 and 76 are executed is the reverse of that shown in FIG. 5. In such embodiments, method 66 involves selecting one or more content items by executing blocks 68 and 70, then executing block 72 to convert one content item to a first presentation object, then executing block 76 to assemble that first presentation object into a given presentation message, then executing block 74 to determine whether there are more content items. In this manner, each presentation object is assembled into a given presentation message before converting another content item to the next presentation object, thereby permitting the given presentation message to incrementally increase in size with each newly converted content item.

After executing block 76, the processor 14 is directed to execute block 78, which directs the processor 14 to determine whether there are more presentation messages. If the processor 14 determines that there are more presentation messages, such as there being more presentation messages that can be generated from the web feeds retrieved by block 62 (FIG. 4), the processor 14 is directed to execute block 68 to select a next content item.

Still referring to FIG. 5 and with reference to the first embodiment, the system 10 is operable to assemble one or more presentation objects into one or more, including possibly all, presentation messages associated with one or more, including possibly all, mobile telephones 30 for which invocation occurs in accordance with block 60 (FIG. 4).

If the processor 14 determines by executing block 78 that there are no more presentation messages to be generated, then the processor 14 is directed to execute block 80, which directs the processor 14 to deliver the presentation message. In the first embodiment, the system 10 is operable to deliver one or more, including possibly all, presentation messages associated with one or more, including possibly all, mobile telephones 30 for which invocation occurs in accordance with block 60 (FIG. 4). Delivering presentation messages may involve delivering a given presentation message to multiple mobile telephones 30, and may involve delivering a plurality of presentation messages to a given mobile telephone 30, for example.

In the first embodiment, delivering the presentation message involves transmitting the presentation message (or presentation messages) produced by block 76 to the telecommunications infrastructure 34 for delivery to the given mobile telephone 30. In general, however, the scope of the present invention contemplates any suitable method of delivering the presentation message to the given mobile telephone 30. In some embodiments, delivering the presentation message includes setting the transmission flag to indicate previous use of the content items that were converted to the presentation objects assembled into the presentation message being transmitted for delivery. In some embodiments, delivering the presentation message includes storing the setting for the transmission flag in the database 18 in association with item references identifying the content items used in the presentation message being transmitted for delivery to the given mobile telephone 30.

After executing block 80, the processor 14 is directed to end the method 66 and return to the method 38 (FIG. 2).

While FIG. 5 shows block 80 being executed after exiting the loop shown as containing blocks 68 to 78, in some embodiments block 80 is executed immediately after executing block 76 and prior to executing block 78 such that each newly generated presentation message is transmitted for delivery before commencing to generate a next presentation message.

Referring back to FIG. 2, after block 42 is executed the processor 14 is directed to end the method 38. In some embodiments, however, the processor 14 is directed to execute block 60 of FIG. 4, thereby waiting for the next appropriate invocation time or event to occur. Additionally or alternatively, the processor 14 may be directed to execute the method 44 of FIG. 3 in respect of the same or different mobile telephone 30.

Thus, there is provided a method of producing a presentation message for a mobile device, the method comprising: retrieving syndicated content from a content source; and generating from the syndicated content the presentation message for sequentially presenting on the mobile device one or more content items of the syndicated content.

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

What is claimed is:

1. A method of producing a presentation message for a mobile device, the method comprising:
(a) retrieving syndicated content from a content source; and
(b) generating from said syndicated content said presentation message for sequentially presenting on the mobile device one or more content items of said syndicated content.

2. The method of claim 1 wherein retrieving syndicated content from a content source comprises retrieving said syndicated content in accordance with a configuration parameter selected from the group consisting of a user selection of a web feed, an invocation parameter and a periodicity parameter.

3. The method of claim 1 wherein retrieving syndicated content from a content source comprises retrieving one or more web feeds from said content source when a time value of an invocation parameter occurs.

4. The method of claim 1 wherein retrieving syndicated content from a content source comprises retrieving one or more web feeds from said content source when an event value of an invocation parameter occurs.

5. The method of claim 1 wherein generating from said syndicated content said presentation message for sequentially presenting on the mobile device one or more content items of said syndicated content comprises selecting a content item of said one or more content items.

6. The method of claim 5 wherein selecting a content item of said one or more content items comprises selecting said content item in accordance with an item reference associated with said syndicated content.

7. The method of claim 5 wherein selecting a content item of said one or more content items comprises selecting said content item in accordance with a configuration parameter selected from the group consisting of a maximum content item size parameter and a non-redundancy parameter.

8. The method of claim 5 wherein generating from said syndicated content said presentation message for sequentially presenting on the mobile device one or more content items of said syndicated content comprises determining whether said content item has been used in generating a previous presentation message transmitted for delivery to the mobile device.

9. The method of claim 6 wherein generating from said syndicated content said presentation message for sequentially presenting on the mobile device one or more content items of said syndicated content comprises determining whether a transmission flag associated with said item reference indicates previous use of said content item.

10. The method of claim 5 wherein generating from said syndicated content said presentation message for sequentially presenting on the mobile device one or more content items of said syndicated content comprises converting said content item to a presentation object.

11. The method of claim 10 wherein converting said content item to a presentation object comprises converting said content item to said presentation object in accordance with a configuration parameter selected from the group consisting of a supported media types parameter, a display dimensions parameter and a maximum presentation size parameter.

12. The method of claim 10 wherein generating from said syndicated content said presentation message for sequentially presenting on the mobile device one or more content items of said syndicated content comprises assembling said presentation object into said presentation message.

13. The method of claim 10 wherein generating from said syndicated content said presentation message for sequentially presenting on the mobile device one or more content items of said syndicated content comprises assembling said presentation object into said presentation message in accordance with a configuration parameter selected from the group consisting of a supported media types parameter, a display dimensions parameter, a maximum presentation message size parameter, a maximum number of presentation objects parameter and a service parameter.

14. The method of claim 1 further comprising delivering said presentation message, and setting a transmission flag associated with said presentation message to indicate previous use of said one or more content items, respectively.

15. The method of claim 1 further comprising obtaining one or more configuration parameters in response to receiving a communication originating from the mobile device.

16. The method of claim 15 wherein obtaining one or more configuration parameters in response to receiving a communication originating from the mobile device comprises receiving user input.

17. The method of claim 1 further comprising storing in a database one or more configuration parameters for use in producing said presentation message.

18. A computer program product comprising computer-executable instructions embodied in a recordable computer-readable medium for performing the method of claim 1.

19. A system for producing a presentation message for a mobile device, the system comprising:
(a) a database;
(b) a configuration component for determining a plurality of configuration parameters and storing said plurality of configuration parameters in said database;
(c) a retrieval component for retrieving syndicated content; and
(d) a message generating component for generating from said syndicated content said presentation message for sequentially presenting on the mobile device one or more content items of said syndicated content.

20. A system for producing a presentation message for a mobile device, the system comprising:
(a) configuration means for determining a plurality of configuration parameters;
(b) database means for storing said plurality of configuration parameters;
(c) retrieval means for retrieving syndicated content; and
(d) message generating means for generating from said syndicated content said presentation message for sequentially presenting on the mobile device one or more content items of said syndicated content.
